(19) United States
(12) Patent Application Publication
(10) Pub. No.: US 2010/0257211 A1
(43) Pub. Date: Oct. 7, 2010

(54) GENERATING SEMI-STRUCTURED SCHEMAS FROM TEST AUTOMATION ARTIFACTS FOR AUTOMATING MANUAL TEST CASES

(75) Inventors: Janice R. Glowacki, Rochester, MN (US); John E. Petri, St. Charles, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/419,526

(22) Filed: Apr. 7, 2009

(51) Int. Cl. G06F 17/30; G06F 9/44

(52) U.S. Cl. 707/803; 717/124; 707/E17.044

(57) ABSTRACT

A method of generating test cases for software applications is provided. The method includes: processing a plurality of artifacts that are associated with a software application; and building a schema definition based on the processing of the plurality of artifacts, wherein the schema definitions are used to build test cases.

### BACKGROUND

The present invention relates to methods and systems for integrating manual and automated test procedures to test software components.

Test automation involves the use of software to automatically test software components of a software application that, in the past, have been verified by humans via manual steps. For example, a software application including a graphical user interface would require every function (menu options, toolbars, dialog boxes, dynamic workflows, etc.) to be tested. Manual testing can be very time consuming and is often times the cause of delay in the product release. As a result, the cost of producing the product may increase.

Automated testing applications have been developed to test software components in a less time-consuming manner than the manual testing. However, it can be difficult to create effective automated test cases. For example, a non-technical user may have difficulty operating an automated testing application. In such cases, a need arises for integrating manual and automated test procedures to provide more accurate and efficient ways to create automated test cases.

### SUMMARY

The shortcomings of the prior art are overcome and additional advantages are provided through the provision of generating test cases for software applications. In one embodiment, the method includes: processing a plurality of artifacts that are associated with a software application; and building a schema definition based on the processing of the plurality of artifacts, wherein the schema definitions are used to build test cases.

### BRIEF DESCRIPTION OF THE SEVERAL VIEWS OF THE DRAWINGS

The drawings described herein are for illustration purposes only and are not intended to limit the scope of the present disclosure in any way. It should be understood that throughout the drawings, corresponding reference numerals indicate like or corresponding parts and features.

FIG. 1 is a block diagram illustrating a computing system that includes a test application in accordance with an exemplary embodiment.

FIG. 2 is a dataflow diagram illustrating the test application of FIG. 1 in accordance with an exemplary embodiment.

FIG. 3 is an illustration of a schema that can be generated by the test application of FIG. 2 in accordance with an exemplary embodiment.

FIG. 4 is an illustration of a test script that can be generated by the test application of FIG. 2 in accordance with an exemplary embodiment.

FIG. 5 is a flowchart illustrating a schema building method that can be performed by the test application of FIG. 2 in accordance with an exemplary embodiment.

FIG. 6 is a flowchart illustrating a test case building method that can be performed by the test application of FIG. 2 in accordance with an exemplary embodiment.

### DETAILED DESCRIPTION

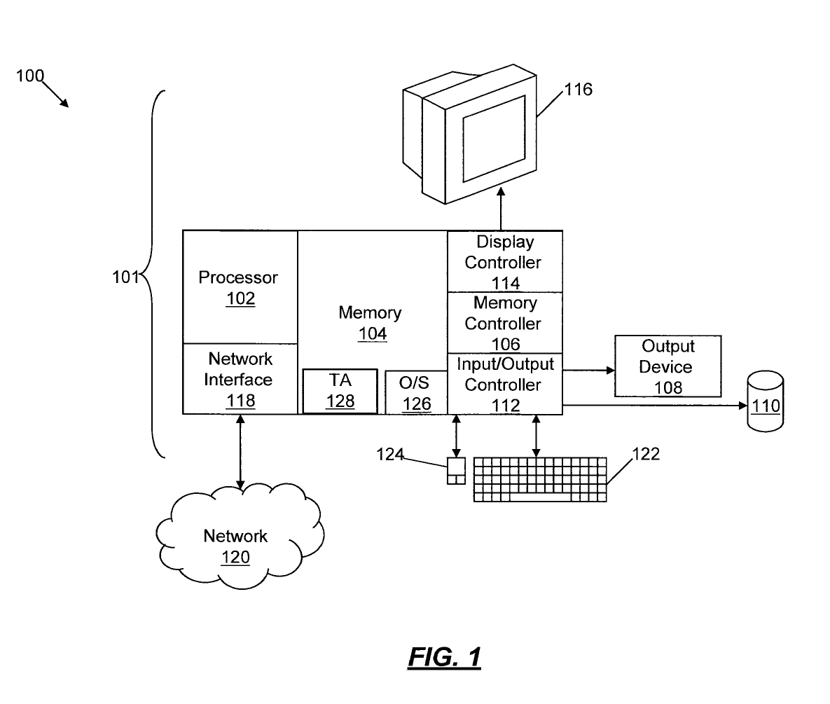

Turning now to FIG. 1, a block diagram illustrates an exemplary computing system 100 that includes testing application in accordance with the present disclosure. The computing system 100 is shown to include a computer 101. As can be appreciated, the computing system 100 can include any computing device, including but not limited to, a desktop computer, a laptop, a server, a portable handheld device, or any other electronic device. For ease of the discussion, the disclosure will be discussed in the context of the computer 101.

The computer 101 is shown to include a processor 102, memory 104 coupled to a memory controller 106, one or more input and/or output (I/O) devices 108, 110 (or peripherals) that are communicatively coupled via a local input/output controller 112, and a display controller 114 coupled to a display 116. In an exemplary embodiment, a conventional keyboard 122 and mouse 124 can be coupled to the input/output controller 112. In an exemplary embodiment, the computing system 100 can further include a network interface 118 for coupling to a network 120. The network 120 transmits and receives data between the computer 101 and external systems.

In various embodiments, the memory 104 stores instructions that can be executed by the processor 102. The instructions stored in memory 104 may include one or more separate programs, each of which comprises an ordered listing of executable instructions for implementing logical functions. In the example of FIG. 1, the instructions stored in the memory 104 include a suitable operating system (OS) 126. The operating system 126 essentially controls the execution of other computer programs and provides scheduling, input-output control, file and data management, memory management, and communication control and related services.

When the computer 101 is in operation, the processor 102 is configured to execute the instructions stored within the memory 104, to communicate data to and from the memory 104, and to generally control operations of the computer 101 pursuant to the instructions. The processor 102 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions.

The processor 102 executes the instructions of a testing application 128 of the present disclosure. In various embodiments, the testing application 128 of the present disclosure is stored in the memory 104 (as shown), is executed from a portable storage device (e.g., CD-ROM, Diskette, FlashDrive, etc.) (not shown), and/or is run from a remote location, such as from a central server (not shown).

Generally speaking, the testing application 128 inspects test automation artifacts, built from a software application and generates a schema to aid a non-technical user in authoring test cases. The test automation artifacts can be predefined and/or defined using the testing application 128.

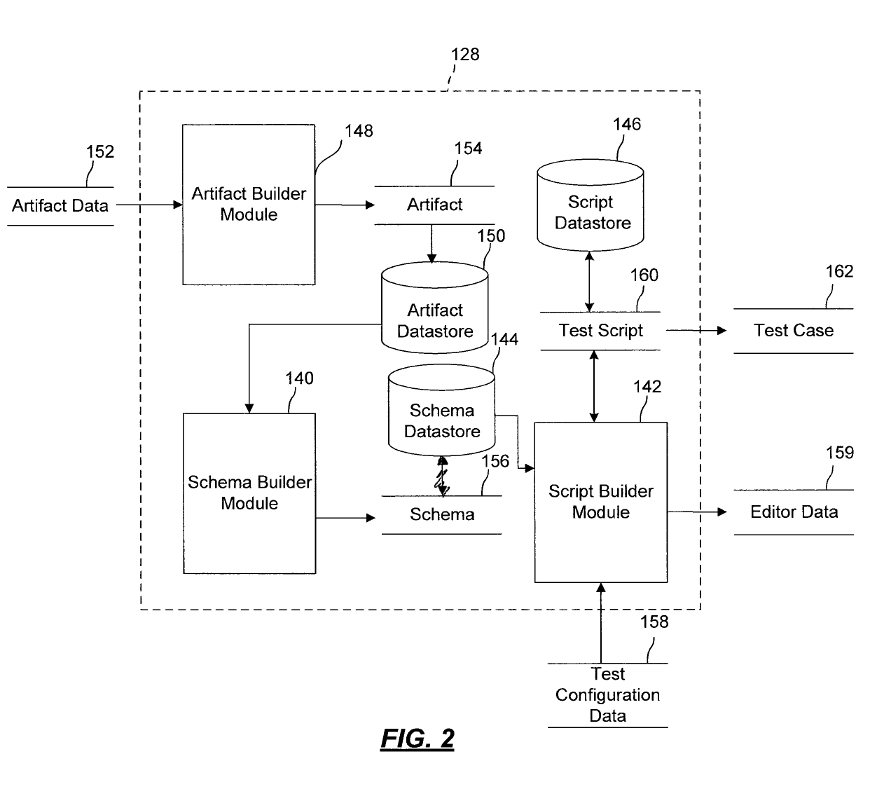

Turning now to FIG. 2, the testing application 128 is shown in more detail in accordance with an exemplary embodiment. The testing application 128 includes one or more modules and datastores. As can be appreciated, the modules can be implemented as a combination of software, hardware, firmware and/or other suitable components that provide the described functionality. As can be appreciated, the modules shown in FIG. 2 can be combined and/or further partitioned to similarly build test cases. In this example, the testing application 128 includes a schema builder module 140, a script builder module 142, a schema datastore 144, a script datastore 146, and optionally, an artifact builder module 148 and an artifact datastore 150.

The artifact builder module 148 receives as input artifact data 152. The artifact data 152 includes data indicating attributes of one or more components of a unit (application) under test. In one example, the artifact data 152 includes data indicating at least one of a name, a type, a function, and/or a relationship to other components and/or the unit under test. Based on the artifact data 152, the artifact builder module 148 generates artifacts 154. As can be appreciated, the generation of the artifacts 154 can be automatic or manual, for example, based on, but not limited to, record-and-playback methods, or by manual configuration. The artifact builder module 148 stores the artifacts 154 to the artifact datastore 150.

In one example, the unit under test is an e-business shopping cart web-page application. In this example, the artifact builder module 148 generates object artifacts and task artifacts where a task artifact is as a series of steps which act on objects in the application under test. The object artifacts can include, for example, a login page artifact, a product search page artifact, a shopping cart artifact (that contains a method for getting the first item in the cart), a checkout page artifact (that contains a method for viewing the message shown to the user). The task artifacts can include, for example, a login artifact (that contains methods for setting a user identification and password before logging in), a search for product artifact (that contains a method for setting a search parameter based on a widget name before performing a search), an add product to cart artifact (that contains a method for adding a widget with a given name to a the cart), and a checkout artifact.

The schema builder module 140 receives as input the artifacts 154 from the artifact datastore 150. Based on the artifacts 154, the schema builder module 140 generates a schema 156 (for example, in XML or some other language) for each artifact 154, a combination of the artifacts 154, and all of the artifacts 154. The schema 156 defines how the artifacts 154 can be used. The schema 156 is generated such that a non-technical user can make use of the objects and tasks.

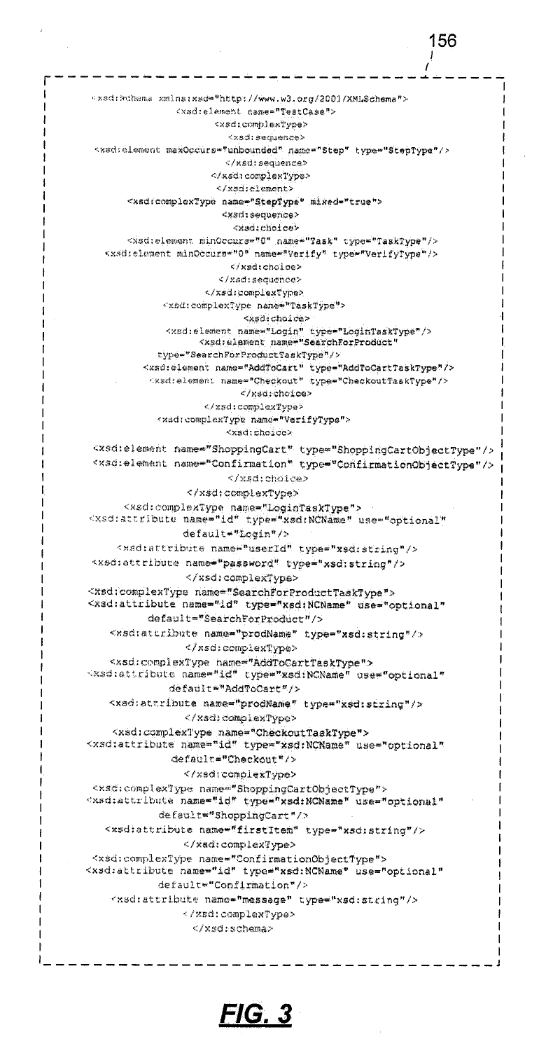

Provided the example above, if the artifact 154 represents a page in a web application, the schema 156 indicates that the page is a verifiable object of the unit under test (via the proper encoding of information in the schema definition). In addition, the schema builder module 140 inspects the artifact 154 to determine if any of its methods represent identifiable objects on the page that a tester may be interested in including in a test case. Likewise, the schema builder module 140 identifies the task artifacts. The schema builder module 140 stores the schema definitions 156 to the schema datastore 144. An exemplary schema 156 is shown in FIG. 3.

As can be appreciated, as the number of artifacts 154 in the artifact datastore 150 increase, the schema builder module 140 regenerates the schema 156 as needed to stay in synch with the artifact datastore 150. When one or more artifacts 154 are removed from the artifact datastore 150, the schema builder module 140 similarly updates the schema datastore 144 by removing the schema 156.

The script builder module 142 receives as input the schema definitions 156 and test configuration data 158. The test configuration data 158 includes input data indicating how a test case is to be configured. In one example, the test configuration data 158 is entered by a user via a user interface (not shown). In another example, the test configuration data 158 includes test scripts (e.g., key-word driven script, or other scripts) that can be incorporated or transformed into a new test script 160 by the script builder module 142.

The script builder module 142 includes an editor. The script builder module 142 loads the schema definitions 156 to the editor. The editor of the script builder module makes the schema definitions available to a user via editor data 159 in a non-technical fashion. Based on the test configuration data 158 entered into the editor and the schema definitions 156, the script builder module 142 builds test scripts 160. The schema builder module 140 makes the test scripts 160 available for a test application via test cases 162. The schema builder module 140 stores the test scripts 160 to the script datastore 146 for reuse by the script builder module 142 or other test applications.

In one example, using the editor of the script builder module 142, the user adds descriptive text to their test script 160 via test configuration data 158. When the test script 160 requires a verifiable object artifact or a task artifact to be included, the user inserts the appropriate reference to the artifact 154 using constraints built into the schema 156 via test configuration data 158.

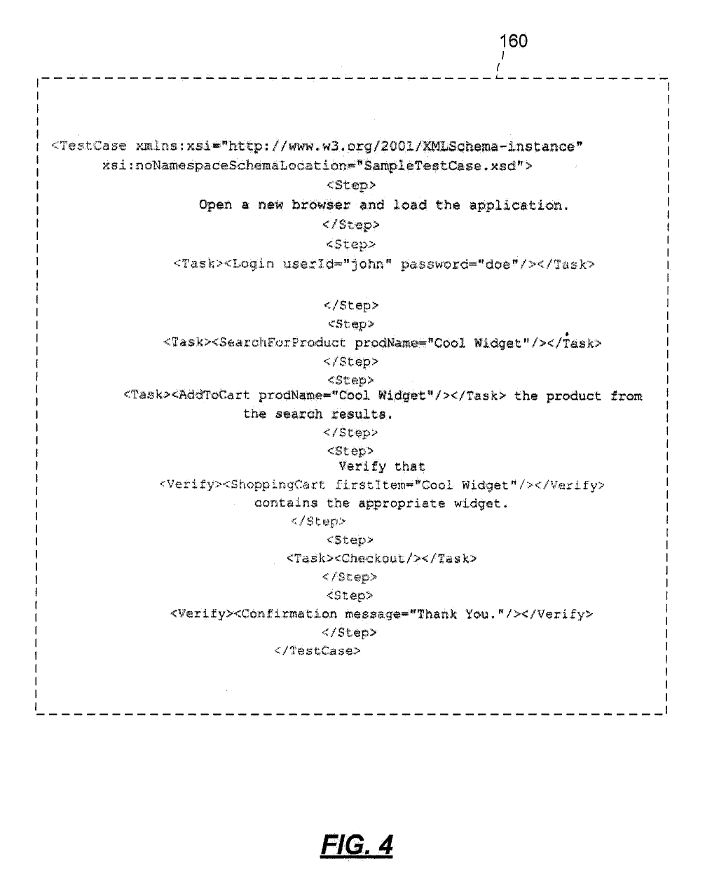

For example, the user enters: “Step 1:”, and then accesses options for the task artifacts or the object artifacts by right clicking. When the user right-clicks the mouse 124 (FIG. 1) in the editor an option list is displayed, including various task artifacts represented by the schema definitions (e.g. “Log in”, “Add Item to Cart”, “Checkout”, etc.). Likewise, later in the test script 160 the user may have a step for verifying that the application is in the correct state. For example, the user enters, “Step 4: Verify that” at this point the user can right-click again in their editor to be presented with a list of artifacts 154 (again, encoded in the schema definition) to verify, such as “Shopping Cart”, “Product”, etc. An exemplary test script 160 is shown in FIG. 4.

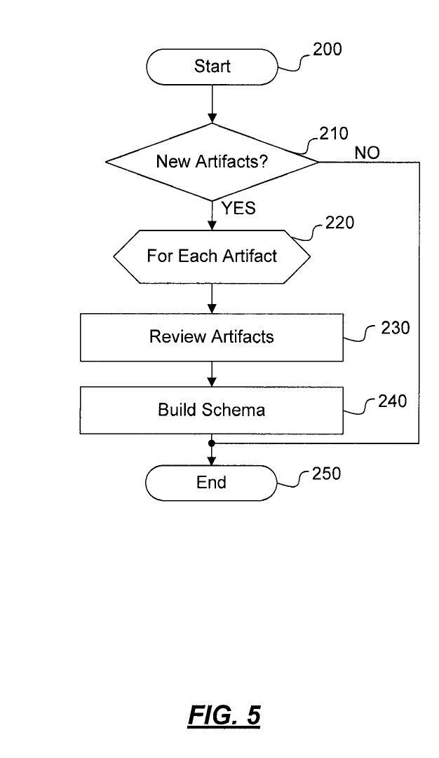

Turning now to FIG. 5 and with continued reference to FIG. 2, a flowchart illustrates a schema building method that can be performed by the testing application 128 of FIG. 2 in accordance with an exemplary embodiment. As can be appreciated in light of the disclosure, the order of operation within the methods is not limited to the sequential execution as illustrated in FIG. 5, but may be performed in one or more varying orders as applicable and in accordance with the present disclosure. As can be appreciated, one or more steps of the method can be added or removed without altering the spirit of the method. As can be appreciated, the method may be scheduled to run based on certain events and/or may run continually (e.g., as a background task) during operation of the testing application.

In one example, the method may begin at 200. In this example, it is assumed that the artifacts 154 are created and stored in the artifact datastore 150 as discussed above. The artifact datastore 150 is monitored for new artifacts 154 at process block 210. If no new artifacts 154 exist at process block 210, the method may end at 250.

If, however, new artifacts 154 have been stored in the artifact datastore 150 at process block 210, each new artifact 154 is processed at process blocks 230 and 240. For each new artifact 154 at process block 220, the artifacts 154 are analyzed in relation to other artifacts 154 at process block 230 and a corresponding schema 156 is built and stored to the schema datastore 144 at process block 240. Once all new artifacts 154 have been processed at process block 220, the method may end at 250.

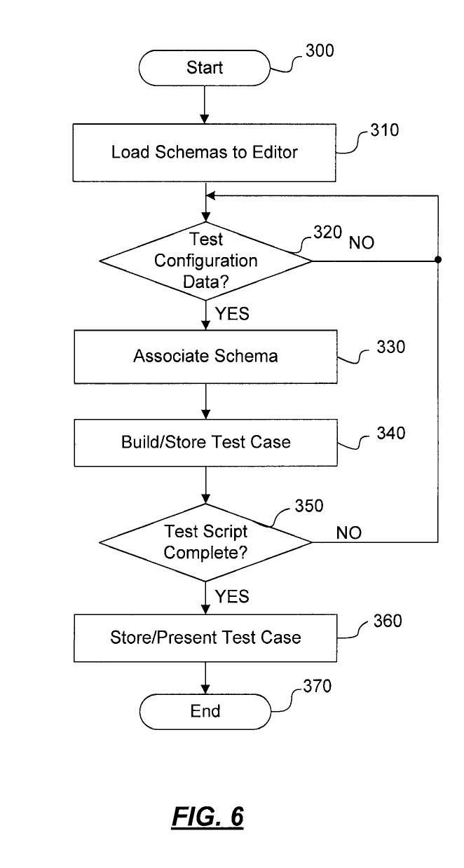

Turning now to FIG. 6 and with continued reference to FIG. 2, a flowchart illustrates a test case building method that can be performed by the testing application 128 of FIG. 2 in accordance with an exemplary embodiment. As can be appreciated in light of the disclosure, the order of operation within the methods is not limited to the sequential execution as illustrated in FIG. 6, but may be performed in one or more varying orders as applicable and in accordance with the present disclosure. As can be appreciated, one or more steps of the method can be added or removed without altering the spirit of the method.

In one example, the method may begin at 300. The schemas 156 are loaded to an editor (e.g., WYSIWYG XML editor) at process block 310. Thereafter, the test script 160 is built based on test configuration data 158 entered by a user via the editor at process blocks 320-340. For example, the input is monitored for test configuration data 158 at process block 320. Once test configuration data 158 is received at process block 320, the test configuration data 158 is associated with a particular schema 156 at process block 330 and incorporated into the test script 160 at process block 340. The method continues until the test script 160 is complete at process block 350. Once the test script is complete at process block 350, the test script 160 may be stored to the script datastore 146 and/or provided as a test case 162 for testing by a testing application at process block 360. Thereafter, the method may end at 370.

As one example, one or more aspects of the present disclosure can be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or provided separately.

Additionally, at least one program storage device readable by a machine, tangibly embodying at least one program of instructions executable by the machine to perform the capabilities of the present disclosure can be provided.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this disclosure, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

While a preferred embodiment has been described, it will be understood that those skilled in the art, both now and in the future, may make various improvements and enhancements which fall within the scope of the claims which follow. These claims should be construed to maintain the proper protection for the disclosure first described.

The terminology used herein is for the purpose of describing particular embodiments only and is not intended to be limiting of the invention. As used herein, the singular forms “a”, “an” and “the” are intended to include the plural forms as well, unless the context clearly indicates otherwise. The corresponding structures, features, materials, acts, and equivalents of all means or step plus function elements in the claims below are intended to include any structure, material, or act for performing the function in combination with other claimed elements as specifically claimed. The disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of generating test cases for software applications, the method comprising:
processing a plurality of artifacts that are associated with a software application; and
building a schema definition based on the processing of the plurality of artifacts, wherein the schema definitions are used to build test cases.

2. The method of claim 1 further comprising building a first test case based on at least one schema definition.

3. The method of claim 2 further comprising storing the first test case to a datastore.

4. The method of claim 3 further comprising building a second test case based on the stored first test case.

5. The method of claim 1 further comprising loading the schema definitions to an editor.

6. The method of claim 1 further comprising building the plurality of artifacts from the software application.

7. The method of claim 1 wherein the artifacts include object artifacts and task artifacts.

8. A system for generating test cases for software applications, the system comprising:
a first datastore that stores a plurality of artifacts that are associated with a software application; and
a schema builder module that evaluates the plurality of artifacts and builds a schema definition based on the evaluation, wherein the schema definitions are used to build test cases.

9. The system of claim 8 further comprising a second datastore that stores the schema definition.

10. The system of claim 9 further comprising a script builder module that loads the schema definitions from the second datastore into an editor.

11. The system of claim 10 wherein the script builder module builds the test cases based on the schema definitions.

12. The system of claim 11 further comprising a third datastore that stores the test cases.

13. The system of claim 12 wherein the script builder module builds test cases from the stored test cases.

14. The system of claim 8 further comprising an artifact builder module that builds the plurality of artifacts based on the software application and that stores the plurality of artifacts to the datastore.

15. The system of claim 8 wherein the artifacts are at least one of object artifacts and task artifacts.

16. A system for generating test cases for software applications, the system comprising:
an artifact builder module that builds a plurality of artifacts based on a software application;
a schema builder module that evaluates the plurality of artifacts and builds a schema definition based on the evaluation; and
a script builder module that builds a test case based on the schema definition.

17. The system of claim 16 further comprising a first datastore that stores the plurality of artifacts.

18. The system of claim 16 further comprising a second datastore that stores the schema definition.

19. The system of claim 18 further comprising a third datastore that stores the test case.

20. The system of claim 16 wherein the script builder module builds the test case from a stored test case.
